(19) United States
(12) Patent Application Publication
(10) Pub. No.: US 2010/0208336 A1
(43) Pub. Date: Aug. 19, 2010

(54) Light conditioner

(76) Inventors: Ernest Ling Tai, Cumming, GA (US); Timothy Alan Chambers, Loganville, GA (US)

Correspondence Address: LW SCIENTIFIC, INC., 865 MARATHON PKWY, LAWRENCEVILLE, GA, 30045, US

(21) Appl. No.: 12/378,783

(22) Filed: Feb. 19, 2009

(51) Int. Cl. G02B 27/28; G02B 13/14

(52) U.S. Cl. 359/355; 359/493

(57) ABSTRACT

This invention pertains to the use of miniaturized filters and light conditioners to enable conventional basic optical equipment such as telescopes, microscope, otoscopes, to be converted to more advanced devices such as a conventional microscope to a metallurgical microscope, or an otoscope to be converted to a fingerprint or trace fluorescence identification device. Additionally this particular invention uniquely creates the means by which a UV light can be cheaply and portably deployed in a field setting without the use of larger or traditional bulky UV lights.

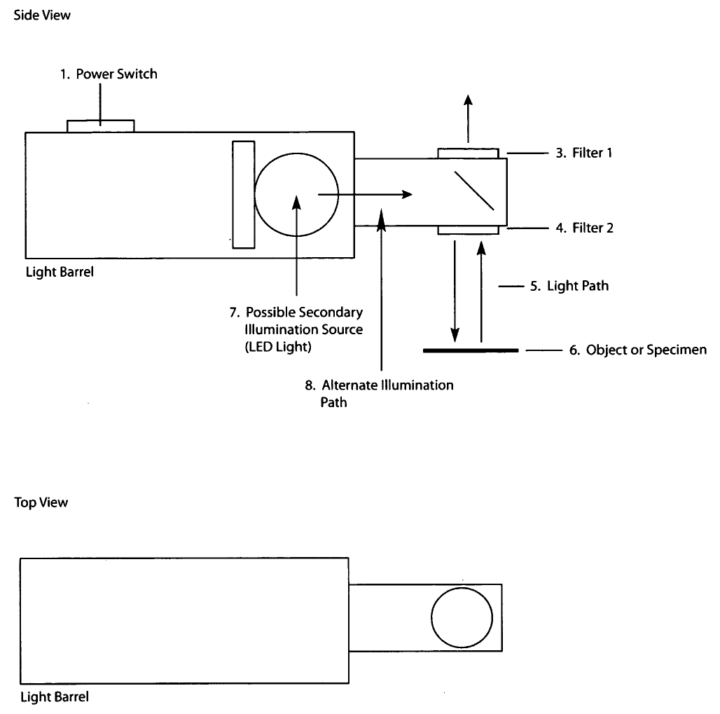

### BACKGROUND OF THE INVENTION

This present invention concerns an illumination device for optical systems. More particularly, the present invention relates to an adapter that contains various filters that enhance and filter light wavelengths so that objects can be viewed with more clarity, contrast, and specificity. Previous to this invention, microscopes, otoscopes, endoscopes, telescopes, and other optical viewing devices relied on complex construction to enable one to view objects or targets through filtered enhancements—for example fluorescence filters for singling out specific wavelengths when fluorochrome stains are used to target specific objects, polarized filters for elimination of light noise needed to examine crystalline structures and metallic structures, and other enhancements that could benefit from a quick insertion of filters and light conditioners in an optical path.

### SUMMARY OF THE INVENTION

It is the object of this invention to provide advanced viewing capability to ordinary optical devices previously only available through complex built-in optical systems.

It is further the object of this invention to provide a means by which any conventional optical device such as a telescope, microscope, otoscope, endoscope, where light and magnification is accomplished through a series of magnifying lenses engineered in a fashion to magnify the view of an object or specimen, can utilize additional enhancement accomplished by this invention, to enable more advanced filters to be easily and employed to increase clarity, specificity, and enhanced viewing.

It is further the object of this invention to be easily removed in such a fashion as to restore the original equipment to original condition without a complex process of disassembly and reassembly.

It is also an object of this invention to provide a means by which any conventional transmitted light device such as a microscope can be converted to an epi-illuminated microscope, and an epi-illuminated microscope can be converted conversely into a transmitted light device.

It is an object also of this invention to provide a means by which a portable ultraviolet light source can be deployed using simple battery or other low voltage power sources.

### DETAILED DESCRIPTION OF THE INVENTION

This invention utilizes a miniaturized barrel with ports on the sides of the barrel that allow light to pass through. This miniaturized barrel enables filters to be inserted into a light path. The filters (drawing objects 3 and 4) as shown in the diagram can therefore introduce the ability to eliminate undesirable wavelengths of light which is primarily the object of polarization or fluorescence.

The present invention therefore is an easy method by which an otoscope for example can utilize light filters to enhance viewing. The eyepiece of an otoscope can be converted using an eyepiece with a lateral hole machined that allows this miniature light conditioner to be inserted in it's body. The invention device would therefore produce an accurate means by which a polarized filter could be placed in the light path to enhance viewing of an object and eliminating light noise. Further, a user could use the invention in any standard optical device by similar means of such hole created in an eyepiece or otherwise in the light path, to insert said filters thus enhancing light. Optical devices employing such eyepieces are commonly employed such as said otoscopes, telescopes, microscopes, lensometers, binoculars, and such.

Further, this invention can be used as a standalone device to filter out unwanted wavelengths of light and produce a more pure ultraviolet (UV) light for example. Where an alternate light source as shown in the drawing (item 7) is used, a filter as shown (item 4) can be deployed to create a pure UV light source. UV light can be used in the curing of various paints and coatings. This invention enables the miniaturized means and therefore a portable and miniature UV light source for various applications such as forensics identification of signatures such as fingerprints, UV cured paint and coating in dental work, UV cured paint in nail polishes or other polishes.

1. We claim the construction of this miniature barrel uniquely enables any transmitted or epi-illuminated optical device to utilize:
a. special miniature polarized filters to accomplished polarization of light view to eliminate un-desirable light noise.
b. Special miniature light filters to accomplish viewing of fluorescently tagged objects or objects naturally exhibiting auto-fluorescing properties

2. Alternatively, this light conditioner provides a portable and miniature means of focusing ultra-violet light (UV) through:
a. The use of an inserted filter to concentrate and focus the light emitted from a light source of the UV spectrum or shorter wavelength.
